(19) United States
(12) Patent Application Publication
(10) Pub. No.: US 2009/0233200 A1
(43) Pub. Date: Sep. 17, 2009

(54) DEVELOPER AND IMAGE FORMING APPARATUS

(75) Inventor: Shiho Moriya, Shizuoka (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/405,394

(22) Filed: Mar. 17, 2009

Related U.S. Application Data
(60) Provisional application No. 61/037,043, filed on Mar. 17, 2008.

(51) Int. Cl. G03G 9/00; G03G 15/08

(52) U.S. Cl. 430/108.1; 399/252; 430/108.7

(57) ABSTRACT

A developer to be used in an image forming apparatus includes a toner containing a core toner including a colorant, a binder resin, a release agent and a charge controlling agent containing Al and Mg, a first inorganic oxide externally added to the core toner, having a primary particle diameter of from 51 to 200 nm in an amount of from 0.2 to 5.0 wt % based on the core toner, and a second inorganic oxide externally added to the core toner, having a primary particle diameter of from 8 to 50 nm in an amount of from 0.2 to 4.0 wt % based on the core toner, and a carrier having a volume resistivity under an electric field of 1000 V/mm of from 1×10⁺⁵ to 1×10⁺¹² Ωcm.

### CROSS-REFERENCE TO RELATED APPLICATION

This application is based upon and claims the benefit of priority from the prior U.S. Patent Application No. 61/037,043 filed on Mar. 17, 2008, the entire contents of which are incorporated herein by reference.

### TECHNICAL FIELD

The present invention relates to a developer and an image forming apparatus to be used for forming an image by an electrophotographic system such as a copier or a printer.

### BACKGROUND

In an image forming apparatus of an electrophotographic system, a two-component developer containing a toner and a magnetic carrier for charging the toner is used. With respect to a developing device using such a two-component developer, studies are conducted for improving the development performance, obtaining a high image density and also prolonging the service life.

JP-A-2006-259010 discloses that an image density is increased by controlling the particle diameter and resistance of a carrier. In general, a high image density is easily obtained by decreasing the resistance of a carrier. However, when the resistance of a carrier is further decreased for obtaining a higher image density, a charge imparting capability of a carrier decreases. In an attempt to prolong the service life, there are problems that a carrier is deteriorated and also it is difficult to secure a desired charging property.

For obtaining a toner with a high charging property, various studies are conducted to optimize a charge controlling agent to be added to the toner. For example, US Patent Application Publication No. 2005/0277040 A1 discloses a charge controlling agent containing Al and Mg. However, even if such a charge controlling agent is merely added to a toner, it is difficult to properly control the charging property because the charge amount varies depending on a change in the installation environment. For example, in a high humidity condition, a decrease in the charge amount can be suppressed, however, in a low humidity condition, a problem arises that a charge amount increases too much.

### SUMMARY

According to an aspect of the invention, a developer including a toner containing a core toner including a colorant, a binder resin, a release agent and a charge controlling agent containing Al and Mg, a first inorganic oxide externally added to the core toner, having a primary particle diameter of from 51 to 200 nm in an amount of from 0.2 to 5.0 wt % based on the core toner, and a second inorganic oxide externally added to the core toner, having a primary particle diameter of from 8 to 50 nm in an amount of from 0.2 to 4.0 wt % based on the core toner, and a carrier having a volume resistivity under an electric field of 1000 V/mm of from 1×10⁺⁵ to 1×10⁺¹² Ωcm is provided.

According to another aspect of the invention, a developer including a toner containing a core toner including a colorant, a binder resin, a release agent and a charge controlling agent containing Al and Mg, a first inorganic oxide externally added to the core toner, having a primary particle diameter of from 51 to 200 nm in an amount of from 0.5 to 3.0 wt % based on the core toner, and a second inorganic oxide externally added to the core toner, having a primary particle diameter of from 8 to 50 nm in an amount of from 0.5 to 2.0 wt % based on the core toner, and a carrier having a volume resistivity under an electric field of 1000 V/mm of from 1×10⁺⁶ to 1×10⁺¹¹ Ωcm is provided.

According to still another aspect of the invention, an image forming apparatus including an image carrying body on which an electrostatic latent image is formed, and a developing device configured to accommodate a developer having a toner which develops the electrostatic latent image on the image carrying body and a carrier having a volume resistivity under an electric field of 1000 V/mm of from 1×10⁺⁵ to 1×10⁺¹² Ωcm is provided. The toner contains a core toner including a colorant, a binder resin, a release agent and a charge controlling agent containing Al and Mg, having externally added thereto, a first inorganic oxide having a primary particle diameter of from 51 to 200 nm in an amount of from 0.2 to 5.0 wt % based on the core toner and a second inorganic oxide having a primary particle diameter of from 8 to 50 nm in an amount of from 0.2 to 4.0 wt % based on the core toner.

It is to be understood that both the foregoing general description and the following detailed description are exemplary and explanatory only and are not restrictive of the invention, as claimed.

### DESCRIPTION OF THE DRAWINGS

The accompanying drawings, which are incorporated in and constitute a part of this specification, illustrate an embodiment of the invention and together with the description, serve to explain the principles of the invention.

FIG. 1 is a structure of an image forming apparatus according to an embodiment of the invention; and

FIG. 2 is a table showing compositions and evaluation results of developers of Examples and Comparative examples according to an embodiment of the invention.

### DETAILED DESCRIPTION

Reference will now be made in detail to the present embodiment of the invention, an example of which is illustrated in the accompanying drawings.

A developer of this embodiment includes a toner containing a core toner including a colorant, a binder resin, a release agent and a charge controlling agent containing Al and Mg, having externally added thereto, a first inorganic oxide having a primary particle diameter of from 51 to 200 nm in an amount of from 0.2 to 5.0 wt % based on the core toner and a second inorganic oxide having a primary particle diameter of from 8 to 50 nm in an amount of from 0.2 to 4.0 wt % based on the core toner, and a carrier having a volume resistivity under an electric field of 1000 V/mm of from 1×10⁺⁵ to 1×10⁺¹² Ωcm.

In the core toner, as the colorant, carbon black, a yellow pigment which is generally used for a toner such as P.Y.180, P.Y.74, P.Y.17, P.Y.185 or P.Y.93, a magenta pigment which is generally used for a toner such as P.R.122, P.R.185, P.R.57:1, P.R.31, P.R.238, P.R.269, P.R.146, P.R.147, P.R.184 or P.V.19, a cyan pigment which is generally used for a toner such as P.B.15 or P.G.7 can be used.

As the binder resin, a polyester resin, a styrene-acrylic resin, a mixture thereof or the like is used.

When the polyester resin is used, the polyester resin can be obtained by using a monomer containing an acid component composed of a divalent or more polyvalent carboxylic acid compound and an alcohol component composed of a dihydric or more polyhydric alcohol.

Examples of the acid component include fumaric acid, maleic acid, citraconic acid, itaconic acid, glutaconic acid, phthalic acid, isophthalic acid, terephthalic acid, cyclohexanedicarboxylic acid, succinic acid, adipic acid, sebacic acid, azelaic acid, malonic acid, succinic acids substituted with an alkyl group having from 1 to 20 carbon atoms or an alkenyl group having from 2 to 20 carbon atoms such as dodecenylsuccinic acid and octylsuccinic acid, and anhydrides of these acids, and alkyl ester of these acids derivatives and the like.

Examples of the alcohol component include aliphatic polyols such as ethylene glycol, propylene glycol, 1,4-butanediol, 1,3-butanediol, 1,5-pentanediol, 1,6-hexanediol, neopentyl glycol, glycerin, trimethylolethane, trimethylolpropane and pentaerythritol; alicyclic polyols such as 1,4-cyclohexanediol and 1,4-cyclohexanedimethanol; and ethylene oxide or propylene oxide adducts such as bisphenol A.

When a styrene-acrylic resin is used, examples thereof include styrene polymers, styrene-diene copolymers and styrene-alkyl(meth)acrylate copolymers.

As the release agent, a natural wax such as carnauba wax or rice wax; a synthetic wax such as polypropylene wax or polyethylene wax can be used.

Further, the core toner contains a charge controlling agent (CCA) for controlling a frictional charge amount (charge amount). Examples of the charge controlling agent include metal-containing azo compounds, metal-containing salicylic acid derivative compounds and hydrophobized metal oxides, all of which contain Al and Mg. The charge controlling agent containing Al and Mg can maintain a high charging property and suppress a decrease in the charge amount over time due to incorporation of Al and Mg therein as metal elements. As the metal element, further, Fe, Cr or Zr may be contained therein. Further, one or more charge controlling agents of different types other than these can also be used in combination.

An addition amount of the charge controlling agent is preferably from 0.5 to 2 parts by weight based on 100 parts by weight of the binder resin. It is because if the addition amount is less than 0.5 parts by weight, it is difficult to impart a sufficient charging property, and if the addition amount exceeds 2 parts by weight, a charge amount increases too much particularly in a low humidity condition. More preferably, the addition amount is from 0.7 to 1.5 parts by weight.

To the core toner surface, a first inorganic oxide having a volume average primary particle diameter of from 51 to 200 nm is externally added. By allowing such an inorganic oxide having a relatively large particle diameter to exist on the core toner surface in this manner, a spacing effect can be obtained. When a developer is used for a long period of time, a spent phenomenon in which components of a toner adhere to the surface of a carrier occurs and the properties of the carrier changes. By the spacing effect, it becomes possible to prevent the change in the properties of the carrier due to the spent phenomenon.

If the primary particle diameter of such an inorganic oxide having a large particle diameter is less than 51 nm or exceeds 200 nm, a proper spacing effect cannot be obtained, resulting in decreasing the charging property, and therefore, a sufficient image density cannot be obtained and fogging occurs. More preferably, the primary particle diameter is from 80 to 130 nm.

Such an inorganic oxide having a large particle diameter should be contained in an amount of from 0.2 to 5.0 wt % based on the core toner. If the amount is less than 0.2 wt %, it is difficult to obtain a sufficient spacing effect and a developing property is deteriorated. On the other hand, if the amount exceeds 5.0 wt %, a fixing property decreases. More preferably, the amount is from 0.5 to 3.0 wt %.

Further, to the core toner surface, a second inorganic oxide having a primary particle diameter of from 8 to 50 nm is externally added. Only with an inorganic oxide having a large particle diameter, the fluidity of the toner is deteriorated. Due to the deterioration of the fluidity of the toner, for example, it is difficult to evacuate the toner from a cartridge for supplying a developer, and the amount of residual toner increases. By allowing such an inorganic oxide having a relatively small particle diameter to exist on the core toner surface in this manner, the fluidity of the toner can be improved and the toner can be prevented from remaining in the cartridge.

If the primary particle diameter of such an inorganic oxide having a small particle diameter is less than 8 nm, it is difficult to prevent the occurrence of poor drum cleaning. On the other hand, if the primary particle diameter exceeds 50 nm, an effect of the addition of particles having a small particle diameter cannot be obtained and it is difficult to prevent the toner from remaining in the cartridge. More preferably, the primary particle diameter is from 8 to 30 nm.

Such an inorganic oxide having a small particle diameter should be contained in an amount of from 0.2 to 4.0 wt % based on the core toner. If the amount is less than 0.2 wt %, the fluidity of the toner is deteriorated and the amount of residual toner in the cartridge increases. On the other hand, if the amount exceeds 4.0 wt %, it is difficult to achieve sufficient drum cleaning. More preferably, the amount is from 0.5 to 2.0 wt %.

As the external additive of the inorganic oxide having a large particle diameter or a small particle diameter, silica, titania, alumina, strontium titanate, tin oxide or the like can be used. Among these, silica is preferably used. As the silica, one which is produced by a baking method or a wetting method and is generally used for a toner can be used.

It is preferred that further a lubricant for a drum cleaner is externally added to the core toner surface. As the lubricant, a higher fatty acid salt of Zn, Ca, Mg or Al (metal soap), a resin containing fluorine or the like can be used.

Such a toner preferably has a volume average particle diameter of from 3 to 7 μm. If the volume average particle diameter is smaller than 3 μm, when an electric charge is imparted to the respective toner particles in an amount that can be controlled by an electric field, the charge amount per weight becomes too large, and therefore it becomes difficult to obtain a desired amount of development. If the volume average particle diameter is larger than 7 μm, reproducibility or graininess of a fine image is deteriorated. More preferably, the volume average particle diameter is from 4 to 6 μm.

The carrier which is contained in the developer and charges the toner should have a volume resistivity under an electric field of 1000 V/mm of from 1×10⁺⁵ to 1×10⁺¹² Ωcm. If the volume resistivity is less than 1×10⁺⁵ Ωcm, it is difficult to secure a sufficient charging property, and toner fogging occurs. On the other hand, if the volume resistivity exceeds 1×10⁺¹² Ωcm, it is difficult to obtain a sufficient image density. More preferably the volume resistivity is from 1×10⁺⁶ to 1×10⁺¹¹ Ωcm.

As the carrier, magnetic particles of ferrite, magnetite, iron oxide or the like, or resin particles mixed with magnetic powder thereof are used. A resin coating layer may be formed on a surface of the carrier.

The carrier preferably has a particle diameter of from 20 to 50 μm. If the particle diameter is smaller than 20 μm, since a magnetic force of one particle is small, the carrier is easily detached from a developer carrying body and adheres to a photoconductor. On the other hand, if the particle diameter is larger than 50 μm, a magnetic brush hardens and brushing traces of the magnetic brush appear on an image or it becomes difficult to perform precise toner supply. More preferably, the particle diameter is from 25 to 40 μm.

By constituting the developer of such a toner and a carrier, a high charging property in the image forming process can be secured, and thus the development performance is improved and a high image density is obtained, and moreover, the service life can be prolonged.

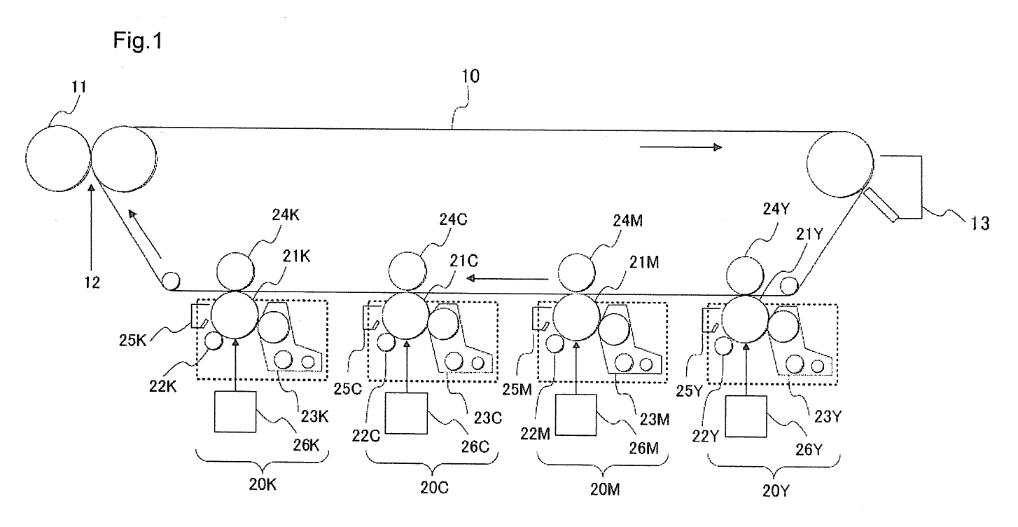

The developer according to this embodiment is applied to an image forming process such as a 4-drum tandem electrophotographic process as described below. FIG. 1 shows a structure of a color printer according to this embodiment serving as a 4-drum tandem image forming apparatus. As shown in FIG. 1, image forming units 20_{Y}, 20_{M}, 20_{C} and 20_{K} are arranged along in a conveying direction (arrow direction) of an intermediate transfer belt 10.

The image forming units 20_{Y}, 20_{M}, 20_{C} and 20_{K} are provided with photoconductive drums 21_{Y}, 21_{M}, 21_{C} and 21_{K} serving as image carrying bodies (electrostatic latent image carrying bodies), respectively. As the photoconductor, a known photoreceptor such as a positively charged or negatively charged OPC (organic photoconductor) or amorphous silicon is used.

The image forming units 20_{Y}, 20_{M}, 20_{C} and 20_{K} further have charging devices 22_{Y}, 22_{M}, 22_{C} and 22_{K} serving as charging units and developing rollers serving as developing members and the like around the respective photoconductive drums, respectively, and the image forming units 20_{Y}, 20_{M}, 20_{C} and 20_{K} are provided with developing devices 23_{Y}, 23_{M}, 23_{C} and 23_{K} which accommodate developers containing carrier particles and toner particles of respective colors of yellow, magenta, cyan and black, respectively, primary transfer rollers 24_{Y}, 24_{M}, 24_{C} and 24_{K} serving as transfer units, and cleaners 25_{Y}, 25_{M}, 25_{C} and 25_{K} serving as cleaning units. These are arranged along in a rotating direction of the corresponding respective photoconductive drums 21_{Y}, 21_{M}, 21_{C} and 21_{K}.

The respective primary transfer rollers 24_{Y}, 24_{M}, 24_{C} and 24_{K} are arranged inside the intermediate transfer belt 10, and sandwich the intermediate transfer belt 10 with the corresponding photoconductive drums 21_{Y}, 21_{M}, 21_{C} and 21_{K}. Exposing devices 26_{Y}, 26_{M}, 26_{C} and 26_{K} are arranged such that an exposure point is formed between each of the charging devices 22_{Y}, 22_{M}, 22_{C} and 22_{K} and each of the developing devices 23_{Y}, 23_{M}, 23_{C} and 23_{K} on an outer circumferential surface of each of the photoconductive drums 21_{Y}, 21_{M}, 21_{C} and 21_{K}. A secondary transfer roller 11 is arranged outside the intermediate transfer belt 10 such that it is in contact with the intermediate transfer belt 10.

Using such an image forming apparatus, an image is formed as described below. First, the charging device 22_{Y} negatively charges the photoconductive drum 21_{Y} uniformly. On the charged photoconductive drum 21_{Y}, an electrostatic latent image is formed by performing exposure according to image information by the exposing device 26_{Y}.

The electrostatic latent image on the photoconductive drum 21_{Y} is reversely developed by the developing device 23_{Y}, and a toner image is formed on the photoconductive drum 21_{Y}.

A bias voltage (+) having a polarity opposite to that of the toner is applied to the primary transfer roller 24_{Y} by a power source (not shown), and a transfer electric field is formed between the photoconductive drum 21_{Y} and the primary transfer roller 24_{Y}. As a result, the toner image on the photoconductive drum 21_{Y} is primarily transferred to the intermediate transfer belt 10 by the transfer electric field when the toner image passes between the photoconductive drum 21_{Y} and the primary transfer roller 24_{Y}. On the photoconductive drum 21_{Y} after the transfer, after cleaning is performed by the cleaner 25_{Y}, the process of charging, exposure and development is repeated again.

In this manner, the toner image is formed in the image forming unit 20_{Y}. In accordance with the timing of the toner image formation in the image forming unit 20_{Y}, the same process is performed also in the image forming units 20_{M}, 20_{C} and 20_{K}. The magenta, cyan and black toner images formed on the photoconductors in the image forming units 20_{M}, 20_{C} and 20_{K} are also sequentially primarily transferred to the intermediate transfer belt 10.

A transfer medium 12 is conveyed from a cassette (not shown) and fed to the intermediate transfer belt 10 by an aligning roller (not shown) in accordance with the timing of the toner image on the intermediate transfer belt 10.

A bias voltage (+) having a polarity opposite to that of the toner is applied to the secondary transfer roller 11 by a power source (not shown). As a result, the toner image on the intermediate transfer belt 10 is transferred to the transfer medium 12 by a transfer electric field formed between the intermediate transfer belt 10 and the secondary transfer roller 11. A fixing device (not shown) which fixes the toner transferred to the transfer medium 12 is provided in the apparatus, and by passing the transfer medium 12 through the fixing device, a fixed image is obtained.

At this time, a portion of the toner (residual transfer toner) which is not completely transferred to the transfer medium 12 and remains on the intermediate transfer belt 10 is cleaned by a cleaner 13.

In the example described above, the image forming units are arranged in the order of yellow, magenta, cyan and black. However, the order of colors is not particularly limited. When a cleanerless process without resort to a cleaner is used, the residual transfer toner is recovered simultaneously with the development.

Hereinafter, the invention will be specifically described with reference to Examples.

### Example 1

Based on a polyester resin, 4 wt % carnauba wax as a release agent, 5 wt % carbon black as a colorant and 1.5 wt % CCA containing Al and Mg are mixed using a Henschel mixer. The resulting mixture is further kneaded using an extrusion-type melt kneader, and then, the kneaded product is pulverized and sieved, whereby a core toner is formed.

To this core toner, as a first inorganic oxide, silica having a primary particle diameter of 100 nm in an amount of 2 wt % based on the core toner and as a second inorganic oxide, silica having a primary particle diameter of 30 nm in an amount of 2 wt % based on the core toner are added. Further, as a lubricant for a drum cleaner, a metal soap is added thereto in an amount of 0.1 wt %, and these are mixed using a Henschel mixer for a predetermined time to externally add these components to the core toner, whereby a toner is formed.

To the thus obtained toner, a ferrite carrier having a volume resistivity of 1×10⁺⁵Ω is added such that the carrier concentration is 92 wt %, whereby a developer is prepared. The resulting developer is evaluated as follows. The respective evaluations are performed using a multifunction machine e-STUDIO 103500C manufactured by Toshiba in a test environment where the temperature is set to 20 to 25° C., and the humidity is set to 40 to 60%. Each evaluation is performed after 150000 sheets of A4 paper are printed at 8% coverage using a black toner.

### Evaluation for Image Density

After 150000 sheets of paper are printed, a solid image is outputted. A density of the outputted image is measured using MacBeth 191, and a case where the measurement value is 1.3 or more is evaluated as ◯, and a case where it is less than 1.3 is evaluated as X.

### Evaluation for Fogging

After 150000 sheets of paper are printed, a fogging density on a sheet of white paper copy is measured using a photovolt, and a case where the fogging density is less than 2% is evaluated as ◯, and a case where it is 2% or more is evaluated as X.

### Evaluation for Residual Toner in Cartridge

Using a cartridge for a multifunction machine e-STUDIO 103500C manufactured by Toshiba, a weight of residual toner in the cartridge when “Toner Empty” is displayed is measured. A case where the weight of residual toner in the cartridge is less than 35 g is evaluated as ◯, and a case where it is 35 g or more is evaluated as x.

### Evaluation for Poor Drum Cleaning

After 150000 sheets of paper are printed, the drum surface and the cleaning blade are observed. A case where poor cleaning due to slipping of the blade or toner filming on the drum does not occur is evaluated as ◯, and a case where either of these occurs is evaluated as X.

### Evaluation for Poor Fixing

After 150000 sheets of paper are printed, a monochromatic solid image is obtained. A case where offset or image peeling due to faulty fixing does not at all occur is evaluated as ◯, and a case where offset or image peeling due to faulty fixing occurs no matter how slight is evaluated as X.

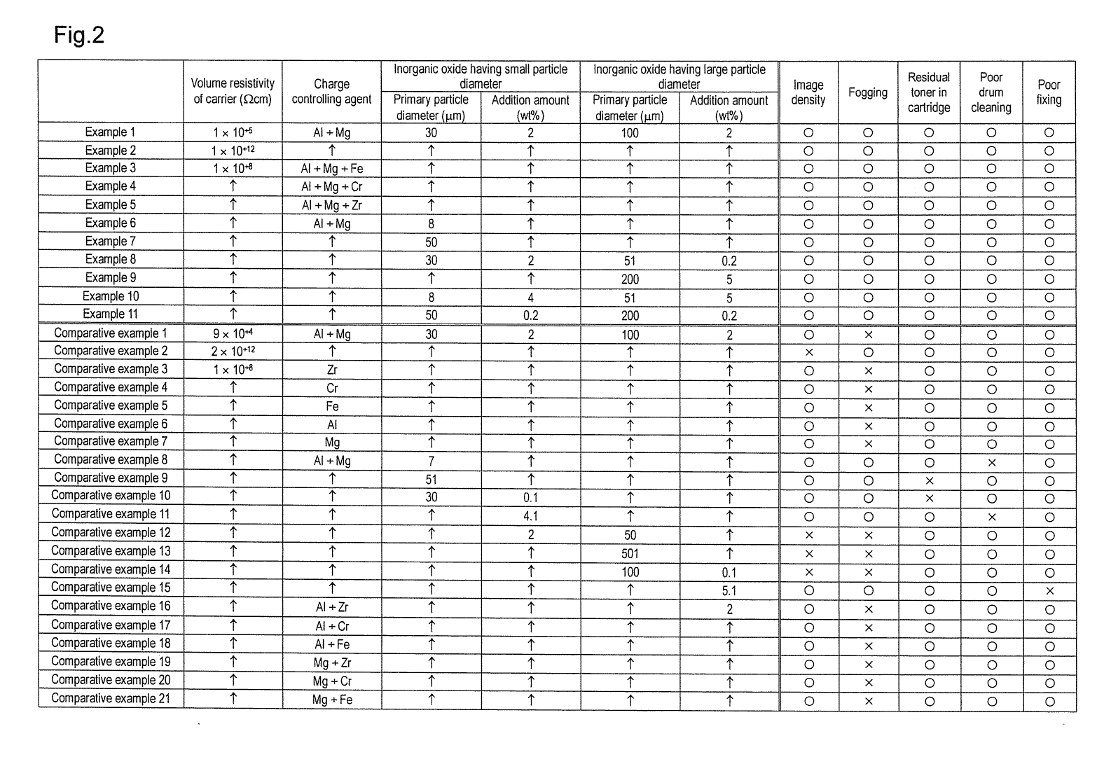

As a result of these evaluations, as shown in FIG. 2, the developer of Example 1 shows good properties with respect to all the evaluation items.

### Example 2

A developer is prepared in the same manner as in Example 1 except that the volume resistivity of the carrier is set to 1×10⁺¹² Ωcm, and evaluations are performed in the same manner as in Example 1. As shown in FIG. 2, the resulting developer shows good properties with respect to all the evaluation items.

### Example 3

A developer is prepared in the same manner as in Example 1 except that the volume resistivity of the carrier is set to 1×10⁺⁸ Ωcm and a charge controlling agent containing Al, Mg and Fe is used, and evaluations are performed in the same manner as in Example 1. As shown in FIG. 2, the resulting developer shows good properties with respect to all the evaluation items.

### Example 4

A developer is prepared in the same manner as in Example 3 except that a charge controlling agent containing Al, Mg and Cr is used, and evaluations are performed in the same manner as in Example 1. As shown in FIG. 2, the resulting developer shows good properties with respect to all the evaluation items.

### Example 5

A developer is prepared in the same manner as in Example 3 except that a charge controlling agent containing Al, Mg and Zr is used, and evaluations are performed in the same manner as in Example 1. As shown in FIG. 2, the resulting developer shows good properties with respect to all the evaluation items.

### Example 6

A developer is prepared in the same manner as in Example 3 except that a charge controlling agent containing Al and Mg is used and the primary particle diameter of the inorganic oxide having a small particle diameter is set to 8 nm, and evaluations are performed in the same manner as in Example 1. As shown in FIG. 2, the resulting developer shows good properties with respect to all the evaluation items.

### Example 7

A developer is prepared in the same manner as in Example 6 except that the primary particle diameter of the inorganic oxide having a small particle diameter is set to 50 nm, and evaluations are performed in the same manner as in Example 1. As shown in FIG. 2, the resulting developer shows good properties with respect to all the evaluation items.

### Example 8

A developer is prepared in the same manner as in Example 6 except that the primary particle diameter of the inorganic oxide having a small particle diameter is set to 30 nm, and the primary particle diameter of the inorganic oxide having a large particle diameter is set to 51 nm and its addition amount is set to 0.2 wt %, and evaluations are performed in the same manner as in Example 1. As shown in FIG. 2, the resulting developer shows good properties with respect to all the evaluation items.

### Example 9

A developer is prepared in the same manner as in Example 8 except that the primary particle diameter of the inorganic oxide having a large particle diameter is set to 200 nm and its addition amount is set to 5 wt %, and evaluations are performed in the same manner as in Example 1. As shown in FIG. 2, the resulting developer shows good properties with respect to all the evaluation items.

### Example 10

A developer is prepared in the same manner as in Example 6 except that the primary particle diameter of the inorganic oxide having a small particle diameter is set to 8 nm and its addition amount is set to 4 wt % and the primary particle diameter of the inorganic oxide having a large particle diameter is set to 51 nm and its addition amount is set to 5 wt %, and evaluations are performed in the same manner as in Example 1. As shown in FIG. 2, the resulting developer shows good properties with respect to all the evaluation items.

### Example 11

A developer is prepared in the same manner as in Example 6 except that the primary particle diameter of the inorganic oxide having a small particle diameter is set to 50 nm and its addition amount is set to 0.2 wt % and the primary particle diameter of the inorganic oxide having a large particle diameter is set to 200 nm and its addition amount is set to 0.2 wt %, and evaluations are performed in the same manner as in Example 1. As shown in FIG. 2, the resulting developer shows good properties with respect to all the evaluation items.

### Comparative Example 1

A developer is prepared in the same manner as in Example 1 except that the volume resistivity of the carrier is set to 9×10⁺⁴ Ωcm, and evaluations are performed in the same manner as in Example 1. As shown in FIG. 2, the resulting developer shows good results in the evaluations for image density, residual toner in cartridge, poor drum cleaning, and poor fixing. However, because the volume resistivity of the carrier is 9×10⁺⁴ Ωcm which is lower than the defined range, fogging occurs.

### Comparative Example 2

A developer is prepared in the same manner as in Example 1 except that the volume resistivity of the carrier is set to 2×10⁺¹² Ωcm, and evaluations are performed in the same manner as in Example 1. As shown in FIG. 2, the resulting developer shows good results in the evaluations for fogging, residual toner in cartridge, poor drum cleaning, and poor fixing. However, because the volume resistivity of the carrier is 2×10⁺¹² Ωcm which is higher than the defined range, a sufficient image density is not obtained.

### Comparative Example 3

A developer is prepared in the same manner as in Example 3 except that CCA not containing Al and Mg but containing Zr is used, and evaluations are performed in the same manner as in Example 1. As shown in FIG. 2, the resulting developer shows good results in the evaluations for image density, residual toner in cartridge, poor drum cleaning, and poor fixing. However, because CCA does not contain Al and Mg, fogging occurs.

### Comparative Example 4

A developer is prepared in the same manner as in Example 3 except that CCA not containing Al and Mg but containing Cr is used, and evaluations are performed in the same manner as in Example 1. As shown in FIG. 2, the resulting developer shows good results in the evaluations for image density, residual toner in cartridge, poor drum cleaning, and poor fixing. However, because CCA does not contain Al and Mg, fogging occurs.

### Comparative Example 5

A developer is prepared in the same manner as in Example 3 except that CCA not containing Al and Mg but containing Fe is used, and evaluations are performed in the same manner as in Example 1. As shown in FIG. 2, the resulting developer shows good results in the evaluations for image density, residual toner in cartridge, poor drum cleaning, and poor fixing. However, because CCA does not contain Al and Mg, fogging occurs.

### Comparative Example 6

A developer is prepared in the same manner as in Example 3 except that CCA not containing Mg but containing Al is used, and evaluations are performed in the same manner as in Example 1. As shown in FIG. 2, the resulting developer shows good results in the evaluations for image density, residual toner in cartridge, poor drum cleaning, and poor fixing. However, because CCA does not contain Mg, fogging occurs.

### Comparative Example 7

A developer is prepared in the same manner as in Example 3 except that CCA not containing Al but containing Mg is used, and evaluations are performed in the same manner as in Example 1. As shown in FIG. 2, the resulting developer shows good results in the evaluations for image density, residual toner in cartridge, poor drum cleaning, and poor fixing. However, because CCA does not contain Al, fogging occurs.

### Comparative Example 8

A developer is prepared in the same manner as in Example 6 except that the primary particle diameter of the inorganic oxide having a small particle diameter is set to 7 nm, and evaluations are performed in the same manner as in Example 1. As shown in FIG. 2, the resulting developer shows good results in the evaluations for image density, fogging, residual toner in cartridge, and poor fixing. However, because the primary particle diameter of the inorganic oxide having a small particle diameter is 7 nm which is smaller than the defined range, poor drum cleaning occurs.

### Comparative Example 9

A developer is prepared in the same manner as in Example 6 except that the primary particle diameter of the inorganic oxide having a small particle diameter is set to 51 nm, and evaluations are performed in the same manner as in Example 1. As shown in FIG. 2, the resulting developer shows good results in the evaluations for image density, fogging, poor drum cleaning, and poor fixing. However, because the primary particle diameter of the inorganic oxide having a small particle diameter is 51 nm which is larger than the defined range, a good result is not obtained in the evaluation for residual toner in cartridge.

### Comparative Example 10

A developer is prepared in the same manner as in Example 6 except that the primary particle diameter of the inorganic oxide having a small particle diameter is set to 30 nm and its addition amount is set to 0.1 wt %, and evaluations are performed in the same manner as in Example 1. As shown in FIG. 2, the resulting developer shows good results in the evaluations for image density, fogging, poor drum cleaning, and poor fixing. However, because the addition amount of the inorganic oxide having a small particle diameter is less than the defined range, a good result is not obtained in the evaluation for residual toner in cartridge.

### Comparative Example 11

A developer is prepared in the same manner as in Example 6 except that the primary particle diameter of the inorganic oxide having a small particle diameter is set to 30 nm and its addition amount is set to 4.1 wt %, and evaluations are performed in the same manner as in Example 1. As shown in FIG. 2, the resulting developer shows good results in the evaluations for image density, fogging, residual toner in cartridge, and poor fixing. However, because the addition amount of the inorganic oxide having a small particle diameter is more than the defined range, poor drum cleaning occurs.

### Comparative Example 12

A developer is prepared in the same manner as in Example 6 except that the primary particle diameter of the inorganic oxide having a small particle diameter is set to 30 nm and the primary particle diameter of the inorganic oxide having a large particle diameter is set to 50 nm, and evaluations are performed in the same manner as in Example 1. As shown in FIG. 2, the resulting developer shows good results in the evaluations for residual toner in cartridge, poor drum cleaning, and poor fixing. However, because the primary particle diameter of the inorganic oxide having a large particle diameter is smaller than the defined range, a sufficient image density is not obtained and fogging occurs.

### Comparative Example 13

A developer is prepared in the same manner as in Example 6 except that the primary particle diameter of the inorganic oxide having a small particle diameter is set to 30 nm and the primary particle diameter of the inorganic oxide having a large particle diameter is set to 501 nm, and evaluations are performed in the same manner as in Example 1. As shown in FIG. 2, the resulting developer shows good results in the evaluations for residual toner in cartridge, poor drum cleaning, and poor fixing. However, because the primary particle diameter of the inorganic oxide having a large particle diameter is larger than the defined range, a sufficient image density is not obtained and fogging occurs.

### Comparative Example 14

A developer is prepared in the same manner as in Example 6 except that the primary particle diameter of the inorganic oxide having a small particle diameter is set to 30 nm and the addition amount of the inorganic oxide having a large particle diameter is set to 0.1 wt %, and evaluations are performed in the same manner as in Example 1. As shown in FIG. 2, the resulting developer shows good results in the evaluations for residual toner in cartridge, poor drum cleaning, and poor fixing. However, because the addition amount of the inorganic oxide having a large particle diameter is less than the defined range, a sufficient image density is not obtained and fogging occurs.

### Comparative Example 15

A developer is prepared in the same manner as in Example 6 except that the primary particle diameter of the inorganic oxide having a small particle diameter is set to 30 nm and the addition amount of the inorganic oxide having a large particle diameter is set to 5.1 wt %, and evaluations are performed in the same manner as in Example 1. As shown in FIG. 2, the resulting developer shows good results in the evaluations for image density, fogging, residual toner in cartridge, and poor drum cleaning. However, because the addition amount of the inorganic oxide having a large particle diameter is more than the defined range, poor fixing occurs.

### Comparative Example 16

A developer is prepared in the same manner as in Example 3 except that CCA not containing Mg but containing Al and Zr is used, and evaluations are performed in the same manner as in Example 1. As shown in FIG. 2, the resulting developer shows good results in the evaluations for image density, residual toner in cartridge, poor drum cleaning, and poor fixing. However, because CCA does not contain Mg, fogging occurs.

### Comparative Example 17

A developer is prepared in the same manner as in Example 3 except that CCA not containing Mg but containing Al and Cr is used, and evaluations are performed in the same manner as in Example 1. As shown in FIG. 2, the resulting developer shows good results in the evaluations for image density, residual toner in cartridge, poor drum cleaning, and poor fixing. However, because CCA does not contain Mg, fogging occurs.

### Comparative Example 18

A developer is prepared in the same manner as in Example 3 except that CCA not containing Mg but containing Al and Fe is used, and evaluations are performed in the same manner as in Example 1. As shown in FIG. 2, the resulting developer shows good results in the evaluations for image density, residual toner in cartridge, poor drum cleaning, and poor fixing. However, because CCA does not contain Mg, fogging occurs.

### Comparative Example 19

A developer is prepared in the same manner as in Example 3 except that CCA not containing Al but containing Mg and Zr is used, and evaluations are performed in the same manner as in Example 1. As shown in FIG. 2, the resulting developer shows good results in the evaluations for image density, residual toner in cartridge, poor drum cleaning, and poor fixing. However, because CCA does not contain Al, fogging occurs.

### Comparative Example 20

A developer is prepared in the same manner as in Example 3 except that CCA not containing Al but containing Mg and Cr is used, and evaluations are performed in the same manner as in Example 1. As shown in FIG. 2, the resulting developer shows good results in the evaluations for image density, residual toner in cartridge, poor drum cleaning, and poor fixing. However, because CCA does not contain Al, fogging occurs.

### Comparative Example 21

A developer is prepared in the same manner as in Example 3 except that CCA not containing Al but containing Mg and Fe is used, and evaluations are performed in the same manner as in Example 1. As shown in FIG. 2, the resulting developer shows good results in the evaluations for image density, residual toner in cartridge, poor drum cleaning, and poor fixing. However, because CCA does not contain Al, fogging occurs.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A developer comprising:
a toner containing a core toner including a colorant, a binder resin, a release agent and a charge controlling agent containing Al and Mg, a first inorganic oxide externally added to the core toner, the first inorganic oxide having a primary particle diameter of from 51 to 200 nm in an amount of from 0.2 to 5.0 wt % based on the core toner, and a second inorganic oxide externally added to the core toner, the second inorganic oxide having a primary particle diameter of from 8 to 50 nm in an amount of from 0.2 to 4.0 wt % based on the core toner; and
a carrier having a volume resistivity under an electric field of 1000 V/mm of from 1×10⁺⁵ to 1×10⁺¹² Ωcm.

2. The developer according to claim 1, wherein the first inorganic oxide is silica.

3. The developer according to claim 1, wherein the second inorganic oxide is silica.

4. The developer according to claim 1, wherein the first inorganic oxide is externally added in an amount of from 0.5 to 3.0 wt % based on the core toner.

5. The developer according to claim 1, wherein the second inorganic oxide is externally added in an amount of from 0.5 to 2.0 wt % based on the core toner.

6. The developer according to claim 1, wherein the charge controlling agent further contains Fe, Cr or Zr.

7. The developer according to claim 1, wherein the carrier has a volume resistivity under an electric field of 1000 V/mm of from 1×10⁺⁶ to 1×10⁺¹¹ Ωcm.

8. A developer comprising:
a toner containing a core toner including a colorant, a binder resin, a release agent and a charge controlling agent containing Al and Mg, a first inorganic oxide externally added to the core toner, the first inorganic oxide having a primary particle diameter of from 51 to 200 nm in an amount of from 0.5 to 3.0 wt % based on the core toner, and a second inorganic oxide externally added to the core toner, the second inorganic oxide having a primary particle diameter of from 8 to 50 nm in an amount of from 0.5 to 2.0 wt % based on the core toner; and
a carrier having a volume resistivity under an electric field of 1000 V/mm of from 1×10⁺⁵ to 1×10⁺¹² Ωcm.

9. The developer according to claim 8, wherein the first inorganic oxide is silica.

10. The developer according to claim 8, wherein the second inorganic oxide is silica.

11. An image forming apparatus comprising:
an image carrying body for forming an electrostatic latent image on the image carrying body; and
a developing device configured to accommodate a developer having a toner for developing the electrostatic latent image on the image carrying body, and a carrier having a volume resistivity under an electric field of 1000 V/mm of from 1×10⁺⁵ to 1×10⁺¹² Ωcm, the toner containing a core toner including a colorant, a binder resin, a release agent and a charge controlling agent containing Al and Mg, a first inorganic oxide externally added to the core toner, the first inorganic oxide having a primary particle diameter of from 51 to 200 nm in an amount of from 0.2 to 5.0 wt % based on the core toner, and a second inorganic oxide externally added to the core toner, the second inorganic oxide having a primary particle diameter of from 8 to 50 nm in an amount of from 0.2 to 4.0 wt % based on the core toner.

12. The apparatus according to claim 11, wherein the first inorganic oxide is silica.

13. The apparatus according to claim 11, wherein the second inorganic oxide is silica.

14. The apparatus according to claim 11, wherein the first inorganic oxide is externally added in an amount of from 0.5 to 3.0 wt % based on the core toner.

15. The apparatus according to claim 11, wherein the second inorganic oxide is externally added in an amount of from 0.5 to 2.0 wt % based on the core toner.

16. The apparatus according to claim 11, wherein the charge controlling agent further contains Fe, Cr or Zr.

17. The apparatus according to claim 11, wherein the carrier has a volume resistivity under an electric field of 1000 V/mm of from 1×10⁺⁶ to 1×10⁺¹¹ Ωcm.

18. The apparatus according to claim 11, wherein the first inorganic oxide in an amount of from 0.5 to 3.0 wt % based on the core toner and the second inorganic oxide in an amount of from 0.5 to 2.0 wt % based on the core toner are externally added to the core toner, and the carrier has a volume resistivity under an electric field of 1000 V/mm of from 1×10⁺⁶ to 1×10⁺¹¹ Ωcm.

19. The apparatus according to claim 18, wherein the first inorganic oxide is silica.

20. The apparatus according to claim 18, wherein the second inorganic oxide is silica.
